(19) United States
(12) Patent Application Publication
(10) Pub. No.: US 2012/0017697 A1
(43) Pub. Date: Jan. 26, 2012

(54) Multiphase Flow Meter

(76) Inventors: Eduardo Rene Benzo, Buenos Aires (AR); Guillermo Gustavo Amarfil Lucero, Buenos Aires (AR)

(21) Appl. No.: 13/189,724

(22) Filed: Jul. 25, 2011

Related U.S. Application Data
(60) Provisional application No. 61/367,757, filed on Jul. 26, 2010.

(51) Int. Cl. G01F 1/74

(52) U.S. Cl. 73/861.04

(57) ABSTRACT

A multiphase meter for a hydrocarbon-containing flow is provided to estimate the relative amounts of water, oil, and gas in the flow without separating the gas and liquid phases of the flow. The meter comprises a chamber for receiving and directing a flow vertically upward. A first capacitor assembly measures the capacitance about a central flow region of the chamber. A second capacitor assembly measures the capacitance about a peripheral flow region. The meter estimates the water content as a function of the peripheral capacitance and the gas content as a function of the arithmetic difference between the peripheral and central capacitance.

### RELATED APPLICATIONS

This application claims the benefit of, and herein incorporates by reference, our U.S. Provisional Patent App. No. 61/367,757, filed on Jul. 26, 2010.

### FIELD OF THE INVENTION

The present invention relates generally to meters and sensors, and more particularly, to a multiphase flow meter and sensor for a hydrocarbon-containing flow including an oil well, batteries of wells, and oil multiphase pipe lines.

### BACKGROUND

Production from a typical oil well is comprised principally of three components: oil, water and gas. Traditionally, oil wells employ systems of measurement that separate the gas and liquid fractions or phases and measure them separately. When the gas fraction is separated from the liquid fraction, the gas is measured with a gas flow meter. The liquid fraction is measured with a liquid flow meter and a water cut meter. In this way, the percentage of each phase is determined and the volume production of oil, gas and water is obtained.

### SUMMARY

A multiphase meter is provided for measuring the fractional contents of different components of a hydrocarbon-containing multiphase flow, such as production from an oil well, or hydrocarbon flowing through a multiphase pipe line. The multiphase meter estimates the relative amounts of water, oil, and gas without separating the gas and liquid phases of the flow into physically segregated flow channels.

The multiphase meter comprises first and second capacitor circuits for sensing first and second electrical characteristics dependent on the flow. The multiphase meter also comprises circuitry electrically coupled to the first and second capacitor circuits. The circuitry is functionally arranged to evaluate the electrical characteristics from the first and second capacitor circuits to estimate the relative amounts of water, oil, and gas in the flow.

In a preferred embodiment, each sensed electrical characteristic is the capacitance of the respective capacitor circuit or its dielectric medium. In other embodiments, each sensed electrical characteristic is the sensed permittivity, susceptibility, impedance, admittance, or reactance of the respective capacitor circuit or its dielectric medium.

The multiphase meter may be further characterized in that it comprises a chamber for receiving and directing the flow vertically upward. The chamber has a preferably non-circular, rectangular cross-section defining a central flow region unseparated from and in cross-sectional continuity with one or more peripheral flow regions. The chamber is also mounted in a vertical orientation to allow gravity to cause a gas phase of the incoming flow to preferentially concentrate along the central flow region, leaving a liquid phase to preferentially flow through the peripheral flow region.

The multiphase meter may also be characterized in that the first capacitor circuit includes capacitive plates positioned about the central flow region and the second capacitor circuit includes capacitive plates positioned about the one or more peripheral flow regions. The capacitive plates of the first capacitor circuit sense a first electrical characteristic dependent on the flow through the central flow region. The capacitive plates of the second capacitor circuit sense a second electrical characteristic dependent on the flow through the one or more peripheral flow regions.

The multiphase meter may also be characterized in that the first capacitor circuit has a capacitance that is a function of relative water, oil, and gas contents of the flow through the central region, and the second capacitor circuit has a capacitance that is a function of relative water, oil, and gas contents of the flow through the one or more peripheral regions.

The multiphase meter may also be characterized in that the circuitry estimates the relative gas content from the arithmetic difference between the sensed electrical characteristics of the first and second capacitor circuits. Also, the circuitry estimates a relative water content of the flow from the sensed electrical characteristic of the second capacitor circuit. More particularly, the circuitry estimates the relative gas content as a function of the estimated water content and a difference between the sensed electrical characteristics of the first and second capacitor circuits.

The first and second capacitor circuits are each preferably comprised of parallel conductive capacitor plates. Moreover, the plates of the first capacitor circuit are preferably arranged coplanar with the plates of the second capacitor circuit. The flow is directed between the plates, which are electrically insulated from the flow.

The multiphase meter may also be characterized in that the chamber has a chamber entrance and a chamber exit for passing the flow. The minimum distance path for the flow is through the central flow region of the chamber. Therefore, any portion of the flow flowing through the peripheral flow region travels a greater distance than said minimum distance path.

The multiphase meter may also be characterized in that when the chamber is vertically mounted, the chamber entrance is positioned immediately below the central flow region. Also, the chamber entrance has interior sides that taper from a narrow inlet aperture upward and outward toward interior walls of the chamber.

The multiphase meter may also be characterized in that the peripheral flow region comprises two peripheral flow sections adjacent opposite sides of the central flow region. The capacitive plates of the second capacitor circuit are positioned about both peripheral flow sections. The plates of the first capacitor circuit are positioned about the central flow region in between the peripheral flow sections.

The multiphase meter may also be characterized in that the circuitry estimates the relative contents of different components of a flow from a well as a function of interpolated calibration data derived from electrical characteristics sensed from one or more of the capacitor circuits during a calibration procedure in which several known mixtures of simulated production are directed through the multiphase meter.

The multiphase meter may also be characterized in that the circuitry estimates a water content of the flow as a function of interpolated calibration data derived from electrical characteristics sensed from the second capacitor circuit.

The multiphase meter may also be characterized in that calibration data used to estimate water content is interpolated using at least a second-order polynomial fit to data derived from the calibration procedure.

The multiphase meter may also be characterized in that the circuitry estimates a gas content of the flow as a function of the estimated water content and interpolated calibration data relating a difference between the sensed electrical characteristics of the first and second capacitor circuits, for an estimated water content, to an estimated gas content.

The multiphase meter may also be characterized in that calibration data used to estimate gas content is interpolated using a plurality of differently-sloped straight-line segment fits to data derived from the calibration procedure.

The multiphase meter may also be characterized in that the circuitry estimates a gas volume as a function of detected pressure and temperature signals.

The multiphase meter may also be characterized in that the circuitry integrates instantaneously estimated fractional contents of different components of the flow over time in order to obtain more accurate estimates of the fractional contents of different components of the flow.

The multiphase meter may also be characterized in that the first and second capacitor circuits are each comprised of conductors of equal total area and separation, so that if a flow is homogeneous through both the central and peripheral flow regions, the sensed first and second electrical characteristics are approximately the same.

The multiphase meter provides several advantages over the prior art. Eliminating hardware for separating the gas and liquid phases will provide substantial savings during installation and during operation of the oil well, prevent ecological damage by venting gas or oil lost during separation processes, give economic and precise real time information on the composition of multiphase oil well and its evolution, and reduce maintenance. The present invention also enables sensor calibration at a factory, eliminating the necessity of calibration in the field.

### BRIEF DESCRIPTION OF THE DRAWINGS

FIG. 1 is a perspective view of one embodiment of a multiphase meter.

FIG. 2 is a perspective view of the multiphase sensor of the multiphase meter of FIG. 1.

FIG. 3 is a perspective view of an internal aspect of the multiphase sensor of FIG. 2, including the non-cylindrical interior walls forming a chamber, metallic plates of central and peripheral capacitors, and corresponding electric conductors.

FIG. 4 is a frontal view of the chamber area of the multiphase sensor of FIG. 2, when flowing a gas fraction in the form of little gas bubbles.

FIG. 5 is a frontal view of the chamber area of the multiphase sensor of FIG. 2, when flowing a gas fraction in the form of larger gas bubbles.

FIG. 6 is a frontal view of the chamber area of the multiphase sensor of FIG. 2, when flowing a gas fraction in the form of very large gas bubbles.

FIG. 7 is a schematic cross section of the multiphase sensor of FIG. 2, revealing the position of each capacitor assembly in relation to the chamber.

FIG. 8 is a block diagram of one embodiment of electrical and electronic circuitry associated with the multiphase meter.

FIG. 9 is a plot of a curve fitting calibration data that relates detected capacitance with known water content, including crosses representing values obtained during repetitive and successive tests.

FIG. 10 is a time dependent plot of output waveforms of the multiphase sensor and a waveform of the corresponding estimated water fraction signal, in a test procedure using a 40% water cut.

FIG. 11 is a functional flow chart of one embodiment of a process and algorithm, including a table lookup, for estimating a water percent content.

FIG. 12 is another time-dependant plot similar of output waveforms of the multiphase sensor, including waveforms indicating measured and estimated input gas flows.

FIG. 13 is a plot of a family of curves for different water percentage contents fitting calibration data that relates detected capacitive difference signals to known gas flow contents.

FIG. 14 is a functional flow diagram of one embodiment of a process and algorithm for estimating gas content.

FIG. 15 is a time-dependent plot showing the estimated instantaneous gas flow and its integral for a test procedure involving a 28% water cut.

FIG. 16 is a time-dependant plot showing the measured instantaneous gas flow and its integral for the same test procedure used in FIG. 15.

FIG. 17 is a time-dependent plot comparing the integrals of the estimated and measured gas flow from FIGS. 15 and 16.

FIG. 18 is a functional flow diagram of one embodiment of a process and algorithm for estimating the relative volume of gas, water, and oil in a hydrocarbon-containing flow through the multiphase meter.

FIG. 19 is a perspective view of closed loop for testing and calibrating the multiphase meter, with an operator utilizing a control panel.

FIG. 20 is another perspective view of the closed loop of FIG. 19, with the operator positioned on a platform to access a liquid tank.

FIG. 21 is a perspective view of several components of the closed loop of FIGS. 19 and 20.

FIG. 22 is a functional flow diagram of one embodiment of a process and algorithm for calibrating the multiphase meter.

FIG. 23 is a perspective view of an accessory for cleaning the internal walls of the multiphase sensor's chamber.

FIG. 24 is a perspective view of the accessory shown in FIG. 23 revealing the cleaning device.

FIG. 25 is an alternative embodiment of the multiphase sensor, in which multiple plates are provided for enhanced resolution and inhomogeneous flow determination.

FIG. 26 is an alternative embodiment of the multiphase sensor for sensing the relative gas, water, and oil contents of a conductive liquid phase.

FIG. 27 is an alternative embodiment of the multiphase sensor that incorporates a cleaning accessory.

### DETAILED DESCRIPTION

The present specification provides embodiments of a multiphase meter that is characterized by measuring the production of each stage without prior gas separation. The present specification also describes a method for calibrating the multiphase meter. The present specification also describes a method for simulating a multiphase production.

U.S. patent application Ser. Nos. 12/219,421 and 11/402,768, filed on Jul. 22, 2008, and Apr. 13, 2006, respectively, are herein incorporated by reference for all purposes.

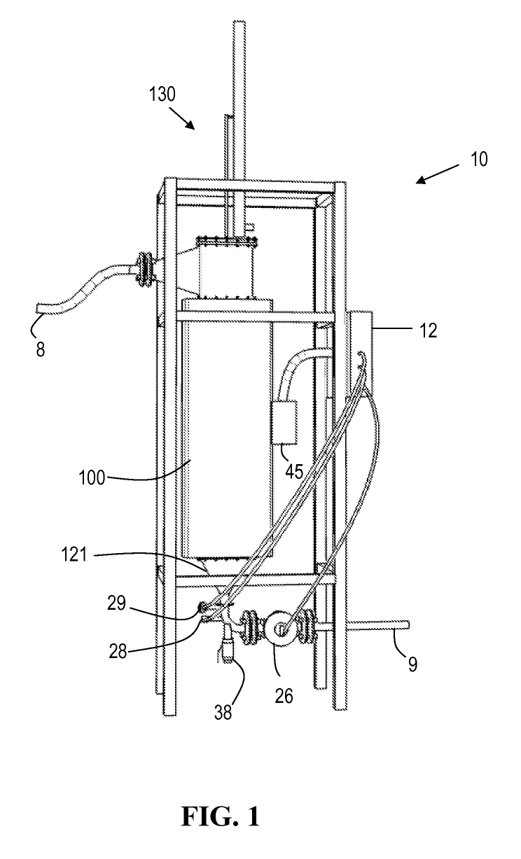

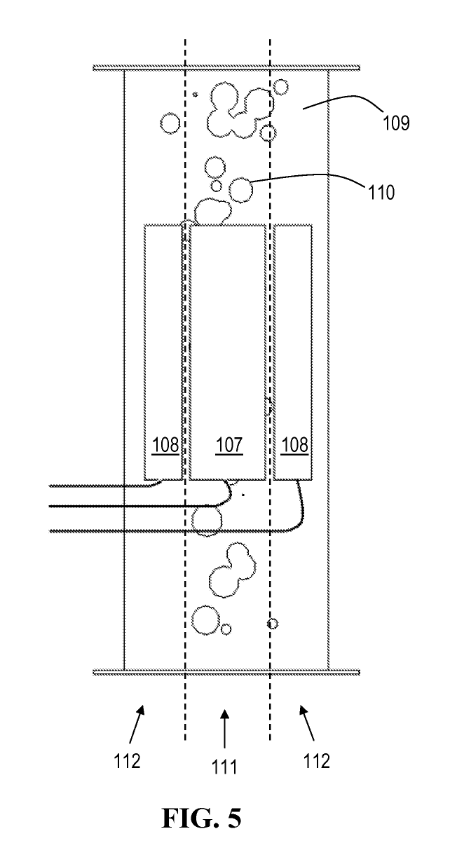

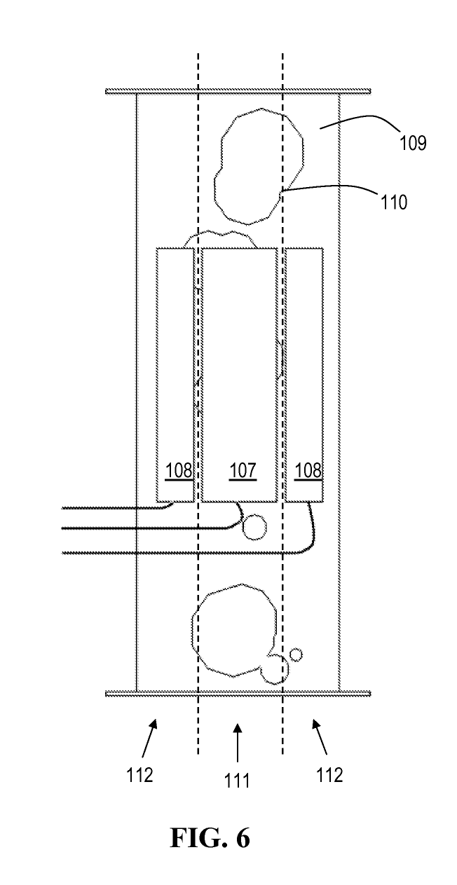

In describing preferred and alternate embodiments of the technology described herein, as illustrated in FIGS. 1-27, specific terminology is employed for the sake of clarity. The technology described herein, however, is not intended to be limited to the specific terminology so selected, and it is to be understood that each specific element includes all technical equivalents that operate in a similar manner to accomplish similar functions.

FIG. 1 illustrates one embodiment of a multiphase meter 10 for a hydrocarbon-containing flow, such as an oil well, designed in accordance with the present invention. The multiphase meter 10 is operable to estimate the percentage composition of each phase (gas, oil, and water) of the flow. In combination with a total flow meter and temperature and pressure sensors, the meter 10 is also operable to estimate both the total volume and the volume of each phase.

The multiphase meter 10 comprises an inlet pipe 9, an outlet pipe 8, a total flow meter 26, a pressure sensor 28, a temperature sensor 29, and a multiphase sensor 100. The multiphase meter 10 also preferably comprises or utilizes circuitry functionally arranged to approximately determine the relative water, oil, and gas contents of a multiphase flow through the meter 10. FIG. 1 illustrates corresponding circuitry in the form of a temperature-controlled electronic oscillator module 45 and an electronic control unit 12. The multiphase meter 10 also preferably comprises or utilizes a cleaning accessory 130 and a valve 38 for emptying the meter 10.

The flow meter 26 may be any suitable, readily available commercial unit for measuring total volume or flow rate of production in an oil well or through a pipeline. The flow meter 26 preferably uses positive-displacement technology to measure the volume or flow rate of multiphase flow.

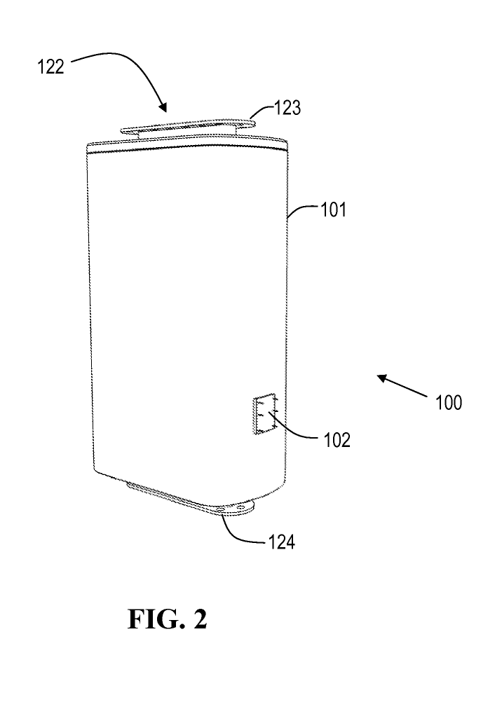

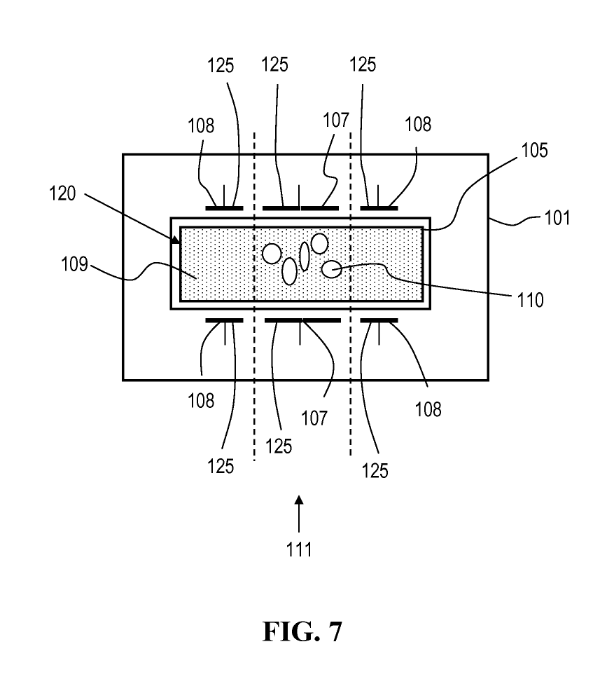

Referring to FIGS. 2-7, the multiphase sensor 100 comprises an electromagnetically-shielding exterior housing 101 and non-conductive interior walls 105 rigidly linked to an inferior flange 124 and a superior flange 123. The interior walls 105 define a channel or chamber 120 for receiving and directing a flow of production vertically upward. As seen especially in FIG. 7, the interior walls 105 are formed with non-cylindrical symmetry, defining a chamber 120 that has a non-circular, rectangular cross-section.

The chamber 120 defines a central flow region 111 unseparated from and in cross-sectional continuity with one or more peripheral flow regions or sections 112. Multiphase flow is passed into the chamber 120 through a chamber entrance 121 centered at the bottom of the chamber 120, immediately below the central flow region 111. Multiphase flow is passed out of the chamber 120 through a chamber exit 122 centered at the top of the chamber 120.

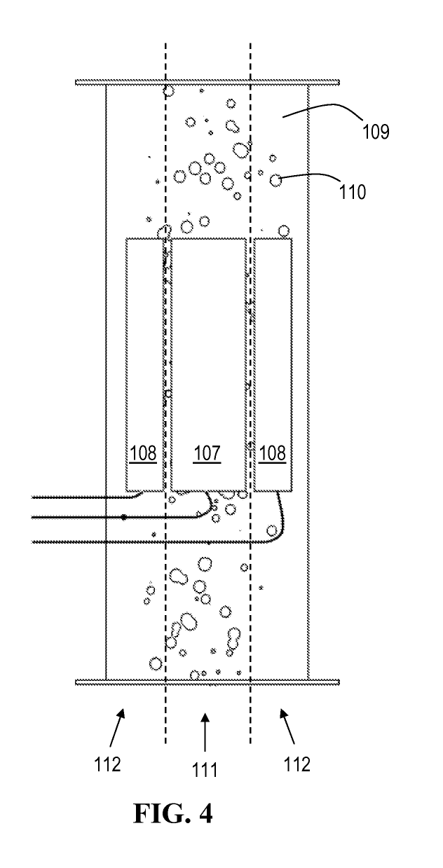

FIGS. 4-7 illustrate the chamber 120 filled with a typical multiphase flow from an oil well. The multiphase flow frequently comprises both a gas phase or fraction 110 and a liquid phase or fraction 109.

The multiphase sensor 100 is installed with the chamber 120 in a vertical orientation. When the chamber 120 is vertically oriented, the gas phase or fraction 110 preferentially flows through the central flow region 111, and the liquid phase or fraction 109 preferentially flows through the peripheral flow region 112. This is because gravity causes the gas fraction 110 of the incoming multiphase flow to preferentially concentrate along the central flow region 111, leaving the liquid fraction 109 to preferentially flow through the peripheral flow region 112. Also, the minimum distance path for a multiphase flow will be through the central flow region 111 of the chamber 120. Any portion of a production flowing through the peripheral flow region(s) 112 will travel a greater distance than said minimum distance path.

The chamber entrance 121 is optionally tapered and shaped in the form of a rectangular funnel having interior sides that taper from a narrow inlet aperture upward and outward toward the interior walls 105. The relatively wider cross-section of the chamber 120 relative to the chamber entrance 121 and exit 122 spread—and slow down the linear travel of—the multiphase flow through the chamber 120. This facilitates increased separation of the liquid phase 109 and gas phase 110 as the production passes through the chamber 120.

Applicant has discovered a fairly reliable correlation between the water cut fraction of production flowing through the peripheral flow region 112 and the capacitive characteristics of the production flowing through that region 112. Applicant has also discovered a fairly reliable correlation between the gas cut fraction of production flowing through the central flow region 111 and the arithmetic difference between the capacitive characteristics of the flows in the central and peripheral regions 111 and 112.

When gas is circulating in the multiphase sensor 100, central capacitance is more reduced than peripheral capacitance. The difference signal between the central and peripheral flow regions 111 and 112 is roughly proportionally increased, making it possible to measure the gas content in the flow. Also, circumstances in which there is no gas, and the liquid fraction is homogeneous throughout the chamber 120, produce roughly equal variations in capacitance in the central and peripheral flow regions 111 and 112.

Accordingly, the multiphase sensor 100 includes first and second capacitor circuits 103 and 104 to sense electrical characteristics dependent on the multiphase flow through the central and peripheral flow regions 111 and 112. The capacitor circuit 103 includes a first or central capacitor assembly 107 positioned about the central flow region 111 of the chamber 120. The second capacitor circuit 104 includes a second or peripheral capacitor assembly 108 positioned about left and right peripheral flow regions 112 of the chamber 120. The sensed electrical characteristic of each circuit 103 or 104 is preferably either its capacitance, periodicity, frequency, impedance, admittance, or reactance, or the permittivity or susceptibility of its dielectric medium, or some value proportional thereto. The sensed electrical characteristics, and the relation between them, provide data for approximately determining the relative water, oil, and gas contents of the multiphase flow.

Each capacitor assembly 107, 108 comprises one or more capacitors having parallel conductive plates 125 positioned adjacent and parallel to the major sides of the rectangular chamber 120. The plates 125 are electrically insulated from any production flowing between the plates 125. The dielectric of each capacitor assembly 107, 108 is dominated and principally represented by the production flowing between the plates 125. The gap or distance between the plates 125 is approximately the same for each capacitor assembly 107, 108.

In the embodiment of FIGS. 2-7, the first capacitor assembly 107 is a single capacitor, and the second capacitor assembly 108 is subdivided in half. Half of the second capacitor assembly 108 is positioned to the right side of first capacitor assembly 107, and the other half of the second capacitor assembly 108 is positioned to the opposite left side of the first capacitor assembly 107. In a physical sense, the second capacitor assembly 108 comprises two identical capacitors situated on opposite sides of the first capacitor assembly 107. However, the plates of each half of the second capacitor assembly 108 are preferably electrically connected in parallel, making their capacitances additive. Therefore, in a logical sense, the second capacitor circuit 104 may be characterized by a single capacitor.

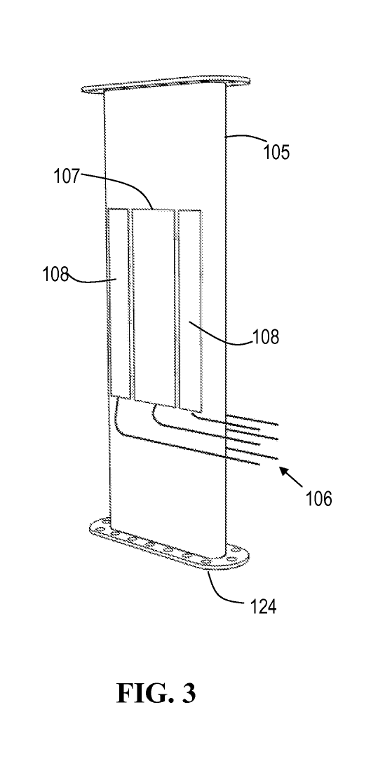

In a preferred embodiment, the plates 125 on each side of the chamber are coplanar with each other. Furthermore, the first and second capacitor assemblies 107 and 108 are each preferably comprised of conductors of equal total area and separation, so that if a flow of production is homogeneous through both the central and peripheral flow regions, the sensed first and second electrical characteristics will be approximately the same. Electrical conductors 106 (FIG. 3) connect the plates 125 to an output electrical connector 102 (FIG. 2).

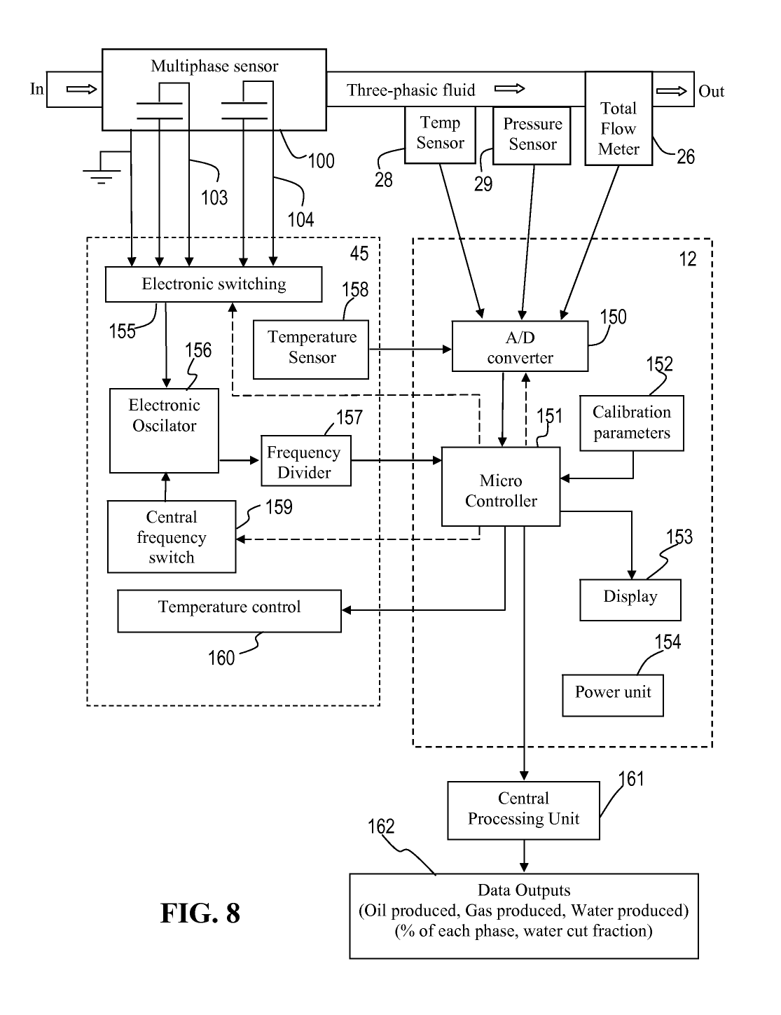

Turning to FIG. 8, the capacitor circuits 103 and 104 of the multiphase sensor 100 are switchably connected to an electronic oscillator module 45. The electronic oscillator module 45 produces electronic signals that are a function of, and preferably proportional to, to the capacitances of the capacitor circuits 103 and 104, and transmits those signals to an electronic control unit 12. These signals are processed by the electronic control unit 12 and further processed in a central processing unit 161 producing data outputs 162.

The electronic oscillator module 45 comprises an electronic oscillator 156 located within a temperature-controlled housing. The electronic oscillator 156 is any suitable oscillator, most preferably a type of relaxation oscillator, that includes a resistor-capacitor (RC) network. The electronic oscillator 156 has an oscillator output 149 (e.g., a regular train of pulses) whose frequency or periodicity is a function of the resistance and capacitance of the RC network. In one embodiment, the electronic oscillator 156 is an astable multivibrator, more specifically, a NAND (or NOR) gate astable multivibrator. In this embodiment, the periodicity of the oscillating output 149 is directly proportional to the capacitance of the RC network. Another suitable form of the electronic oscillator 156 is a Schmitt trigger.

At least part of, and optionally all of, the capacitance of the RC network that, together with the resistance, determines the frequency or periodicity of the oscillator output 149, is switched into the RC network. The electronic oscillator module 45 includes a micro-controller-controlled switch, relay or multiplexer 155 that selectively connects the electronic oscillator 156 to either the first capacitor assembly 107, the second capacitor assembly 108, or ground (or alternatively a reference capacitance), the latter of which is used to generate a diagnostic control signal. At least part, and optionally all, of the capacitance of the RC network of the electronic oscillator 156 is determined by the switched input capacitance.

At least part of the resistance of the RC network that, together with the capacitance, determines the frequency or periodicity of the oscillator output 149, is also microprocessor-controlled. The electronic oscillator module 45 also optionally includes a microprocessor-controlled central frequency switch 159 that short-circuits selected series-connected resistors of the RC network in order to modify the output frequency range of the electronic oscillator 156.

The oscillating output 140 of the electronic oscillator 156, which is preferably binary (i.e., driven between low and high states), is fed into a programmable digital frequency divider or counter 157. The frequency divider 157 divides the frequency by a programmable factor (e.g., 10, 100 or 1000), in order to filter noise and smooth out the frequency signal.

In order to maintain consistency, the electronic oscillator module 45 is preferably temperature-controlled within a range of approximately ±0.5° Celsius. Accordingly, the electronic oscillator module 45 includes a temperature sensor 158 and a temperature control device 160, such as a heater, cooler, fan, heat sink, heat exchanger, heat pump, radiator, or combination of the same.

In another embodiment, not shown in FIG. 8, separate electronic oscillator modules permanently connected to each of the first and second capacitor assemblies 107 and 108 are provided in place of the single electronic oscillator module 45 that is periodically switched between the first capacitor assembly 107 and the second capacitor assembly 108.

The electronic control unit comprises a micro-controller 151, memory 152 storing calibration data or parameters derived from calibration data, one or more analog-to-digital (A/D) converters 150, a display 153, and a power supply 154. The power supply 154 energizes the electronic control unit 12 and the temperature-controlled oscillator chamber 45.

The micro-controller 151 drives switches 155 and 159, temperature control device 160, and display 153. The micro-controller 151 receives digital signals from the frequency divider 157. Additionally, the microcontroller 151 receives, through one or more analog-to-digital (A/D) convertors 150, data from a multiphase flow temperature sensor 28, a multiphase pressure sensor 29, a total flow meter 26, and the electronic oscillator module's temperature sensor 158. Either the micro-controller 151, the central processing unit 161, or both then use the calibration data or parameters in memory 152, together with sensed A/D data and the sensed electrical characteristics from the capacitor circuits 103 and 104, to compute estimated relative fractions of gas, water, and oil content from the multiphase flow. One or more of the sensed signals or computed values is output, in the form of textual outputs, time-varying graphs, or both, on display 153.

Among other functions, the micro-controller 151 periodically cycles the switch 155 between three states, the first state connecting the first capacitor circuit 103 to the electronic oscillator 156, the second state connecting the second capacitor circuit 104 to the electronic oscillator 156, and the third state connecting ground (or a reference capacitor) to the electronic oscillator 156. The micro-controller 151 also maintains the electronic oscillator module 45 at a relatively constant temperature.

In a preferred embodiment, the water content of the liquid fraction of a multiphase flow is estimated as a function of the sensed capacitance of the second capacitor circuit 104, which is a function of the composition of the production flowing through the peripheral flow region 112 of the chamber 120. Because the gas fraction of a production will preferentially flow through the central flow region 111 of the chamber, the production flowing through the peripheral flow region 112 will typically consist mostly or essentially only of a liquid fraction. Tests indicate that the sensed capacitance of the second capacitor circuit 104 is approximately—to a commercially adequate degree of consistency—an invertible function of the water content of the liquid fraction of the production.

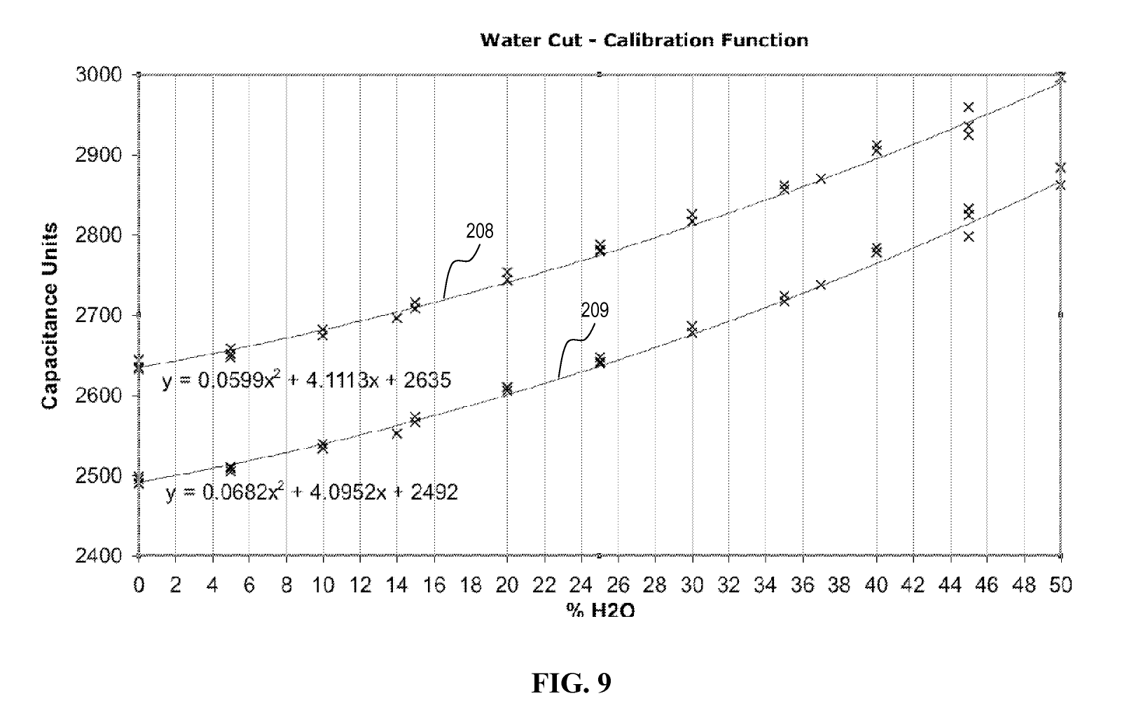

FIG. 9 illustrates a plot of sensed capacitance, versus water fraction, from the multiphase meter 10 over a plurality of calibration procedures using simulated multiphase flows of different mixtures of water and oil without gas. The plot illustrates a first interpolated calibration curve 208 fitting a plurality of calibration data points representing the sensed capacitance of the peripheral capacitor assembly 108. The “capacitance units” represented by the Y axis is a count, over some interval of time, of the number of pulses coming from the frequency divider 157 when the electronic oscillator 156 is switched to the second (or peripheral) capacitor circuit 104. The count represents the periodicity of the RC network formed by the electronic oscillator 156 in conjunction with the peripheral capacitor assembly 108. The periodicity of the oscillating output of the electronic oscillator 156 is directly and approximately linearly proportional to the capacitance of the switched RC network. Therefore, the Y axis is properly characterized in terms of “capacitance units.”

The interpolated calibration curve 208 is interpolated over data derived from simulated multiphase flows for a plurality of water fractions and a plurality of gas fractions. FIG. 9 also illustrates the parameters of a second-order polynomial—which may be re-arranged into the form of a solvable quadratic formula—fitted to the data and used to generate the interpolated calibration curve 208.

FIG. 9 also illustrates a second interpolated calibration curve 209 fitting a plurality of calibration data points representing the sensed capacitance of the central capacitor assembly 107. The second calibration curve 209 is interpolated over data derived from the same set of simulated multiphase flows used to generate the first interpolated calibration curve 208. FIG. 9 also illustrates the parameters of a second-order polynomial used to generate the second calibration curve 209.

The second calibration curve 209 provides information for comparison and contrast with the first calibration curve 208. Curves 208 and 209 are relatively close to each other because the first and second capacitor assemblies 107 and 108 use capacitive plates of approximately equal total area and separation. The curves do not completely overlap, however, due to the different capacitive edge effects between the first and second capacitor assemblies 107 and 108 and tolerances in the fabrication of the respective capacitor assemblies 107 and 108.

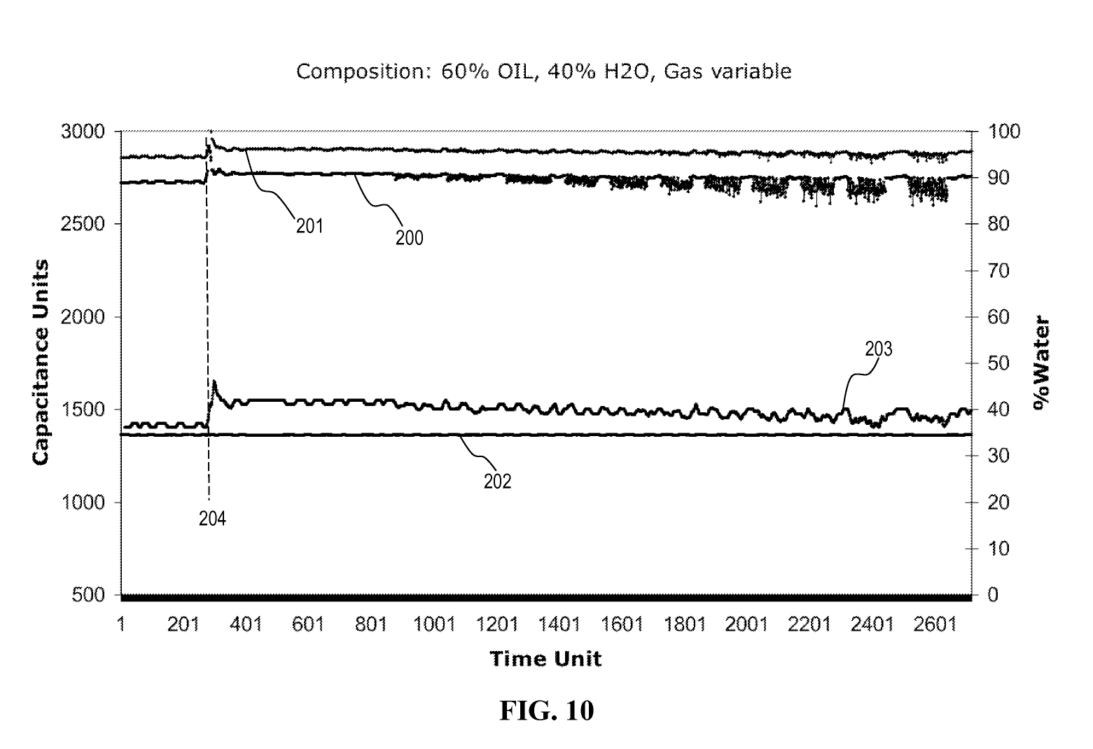

FIG. 10 illustrates a plot of sensed electrical characteristics, versus time, from the multiphase meter 10 in a test procedure that used a simulated multiphase flow. The plot illustrates a first signal 200 representing the sensed capacitance of the first (or central) capacitor assembly 107. The plot also illustrates a second signal 201 representing the sensed capacitance of the second (or peripheral) capacitor assembly 108.

The plot also illustrates a control signal 202 produced when the capacitive input of the electronic oscillator 156 was grounded by switch 155. The control signal 202 was monitored to detect potential malfunctioning of the electronic oscillator module 45. An approximately constant control signal 202 signals successful operation. A spike in control signal 202 signifies possible electromagnetic interference or other errors, in which case corresponding spikes in the first and second signals 200 and 201 would be discarded or disregarded.

The signals 200, 201, and 202 represent measures of the periodicity of the signal derived from the frequency divider 157 of the electronic oscillator module 45 when it is switched to the signal's respective capacitor circuit. Because the periodicity of the oscillating output of the electronic oscillator 156 is directly and approximately linearly proportional to the capacitance of the switched RC network, signals 200 and 201 are directly and approximately linearly proportional to the capacitance of the first and second capacitor circuits 103 and 104, respectively. Accordingly, the left Y-axis of the plot illustrated in FIG. 10—against which each of signals 201, 202, and 203 are plotted—is labeled “capacitance units.”

In the test procedure represented by the plot in FIG. 10, a sudden increase in the water content of the liquid fraction of the simulated production was introduced at time 204. From that time forward, the test procedure utilized a simulated multiphase flow with a liquid fraction that consisted of 60% oil and 40% water.

FIG. 10 also illustrates an estimated water cut fraction 203. The estimated water cut fraction 203 was one of the data outputs 162. It was derived from the sensed capacitance of the second capacitor circuit 104 and the parameters of the interpolated calibration curve 208 of FIG. 9. As illustrated in FIG. 10, the estimated water cut fraction 203 consistently closely approximated the actual 40% water content of the liquid fraction of the simulated production.

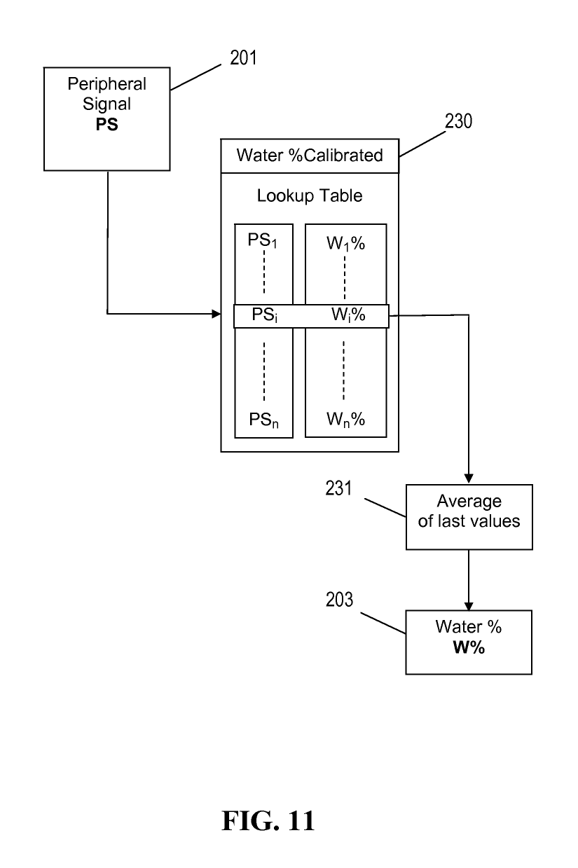

FIG. 11 illustrates one embodiment of a process by which the microcontroller 151 and/or central processing unit 161 estimates the water cut fraction. After the multiphase meter 10 has been calibrated, a lookup table 230 is populated with pairs of values that correlate a plurality of peripheral capacitance values with corresponding water cut fractions. These pairs of values are generated for several possible capacitance signals by solving a quadratic formula that fits the interpolated calibration curve 208 (FIG. 9) to peripheral capacitance versus water cut calibration data. When the multiphase meter 10 is placed in normal field operation, sampled signals 201 representing the sensed capacitance of the second (or peripheral) capacitor assembly 108 are looked up in table 230 to find a corresponding estimated water cut fraction. Because the signal 201 may be noisy, several values of instantaneously estimated water cut fraction are averaged over a period of time (block 231), for example approximately 10 seconds, to generate the estimated water cut fraction 203 illustrated on FIG. 10.

If the microcontroller 151 and/or central processing unit 161 is equipped with sufficient processing power for a given data sampling rate, then it may bypass table 230 and simply solve a quadratic formula that fits the interpolated calibration curve 208 (FIG. 9) to peripheral capacitance versus water cut calibration data every time it is presented with a signal 201.

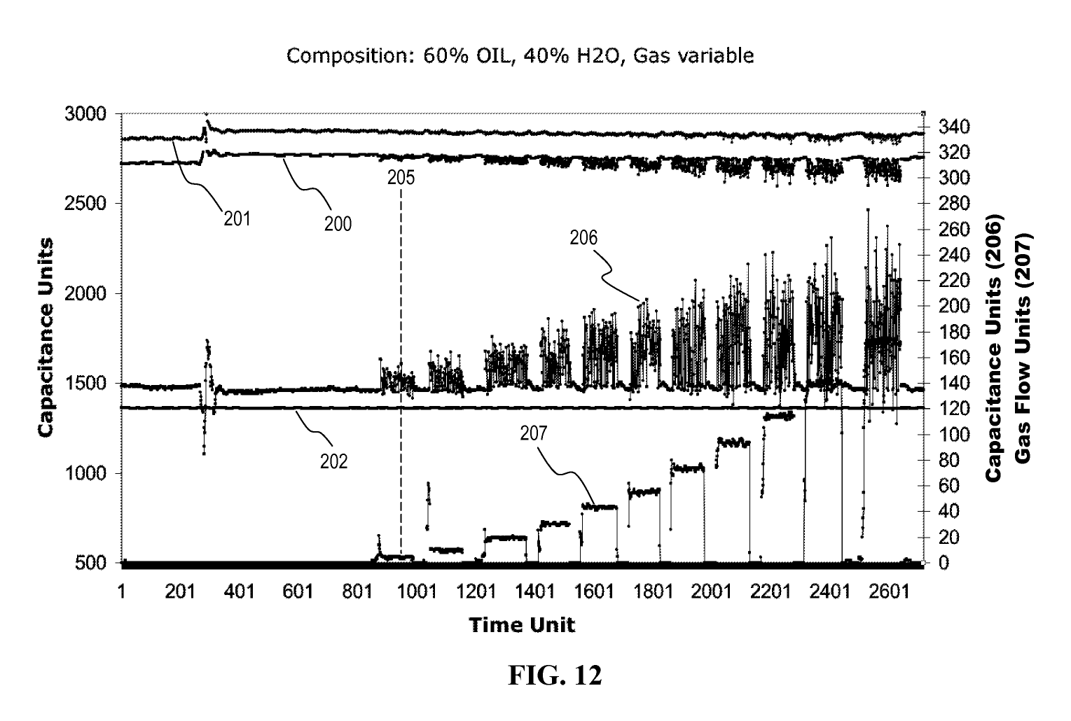

FIG. 12 also illustrates a plot of sensed electrical characteristics, versus time, from the multiphase meter 10 in a test procedure that used a simulated multiphase flow. Like FIG. 10, FIG. 12 illustrates first signal 200, second signal 201, and control signal 202, all plotted in terms of arbitrary “capacitance units” against the left Y-axis. FIG. 12 also illustrates a difference value 206 equal to the instantaneous value of second signal 201 minus the instantaneous value of first signal 202. The difference value 206 is also plotted in terms of the same arbitrary “capacitance units” used for the left Y-axis, but against the scalar values of the second, right Y-axis.

The test procedure represented by FIG. 12, like the test procedure illustrated in FIG. 10, utilized a simulated multiphase flow with a liquid fraction that consisted of 60% oil and 40% water. At time 205, known gas flow rates—illustrated by signal 207—began to be introduced into the simulated multiphase flow. The gas flow rate signal 207 is illustrated in arbitrary units of volume/time, the scalar values of which are represented by the second, right Y-axis. As evident in FIG. 12, there is an invertible functional relationship, and an approximately or roughly linear correlation, between the gas flow rate signal 207 and the difference value 206. Said another way, different gas flows produce roughly proportional variations (although the signals are very noisy) in the difference value 206.

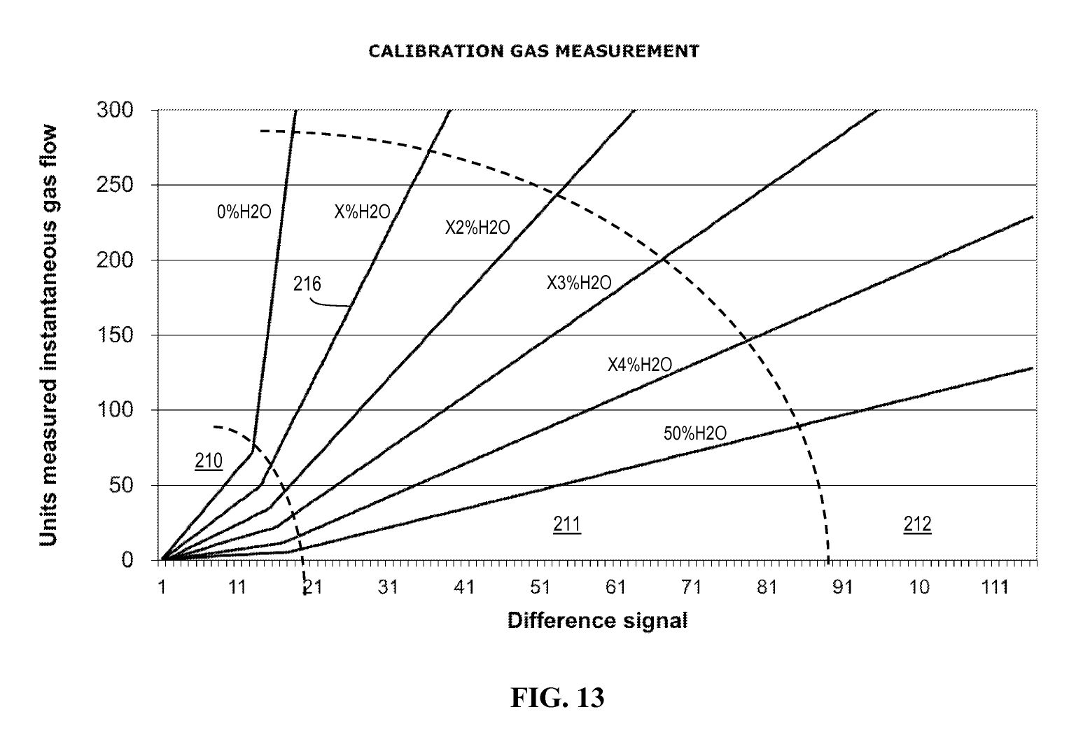

FIG. 13 is a plot illustrating a family of interpolated calibration curves 216 fitting calibration data relating known gas flow rates, capacitive difference signal values, and known water cut fractions. The calibration data is obtained from a plurality of calibration procedures using simulated multiphase flows for a plurality of different gas, water, and oil fractions. The gas flow rates are represented by the Y-axis in arbitrary units of volume/time. The capacitance difference signal values are represented by the X-axis in arbitrary units that are proportional or approximately proportional to the difference between the capacitance of the first and second capacitor assemblies 107 and 108. In FIG. 13, the difference signal values are offset by an amount approximately equal to the average difference signal (i.e., approximately 140 units) between the first and second capacitor assemblies 107 and 108 in gas-free simulated production conditions.

In FIG. 13, separate calibration curves are generated for different water cut fractions. In one embodiment, each calibration curve comprises a plurality of differently-sloped straight-line segments spliced together to fit the relevant calibration data. To illustrate, FIG. 13 depicts a first slope area 210, a second slope area 211 and an optional additional slope area 212, each containing respective linear segments of each calibration curve. Any change in the slope of curves 216 is believed to represent changes of activity in the collision process between bubbles inside the multiphase sensor 100. The calibration curves 216 of FIG. 13 enable the gas content of a real multiphase flow to be estimated as a function of the estimated water content and the difference between the sensed electrical characteristics of the first and second capacitor circuits 103 and 104.

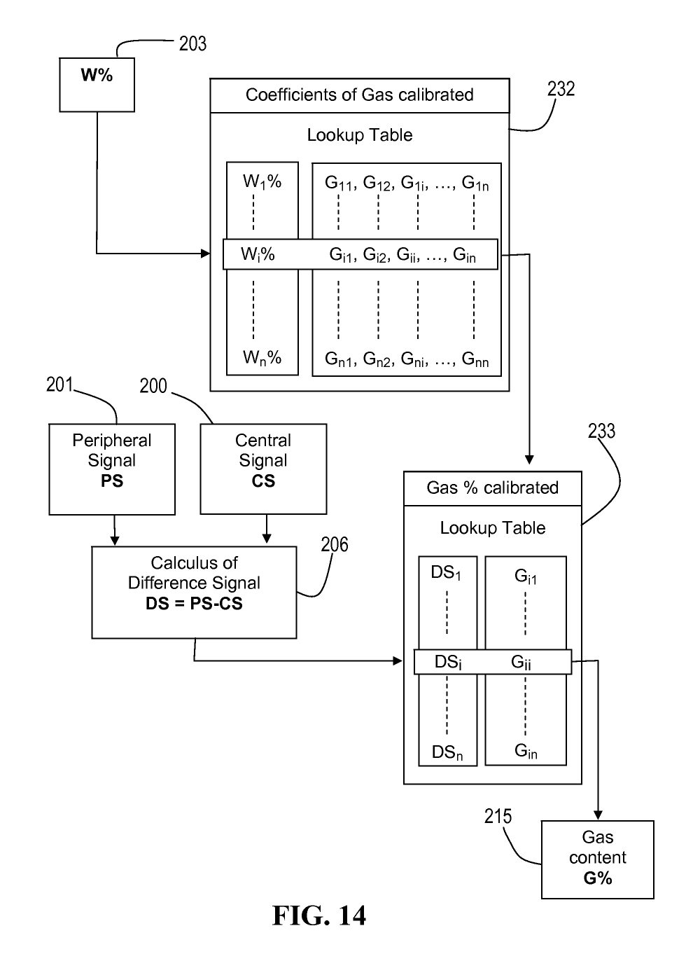

FIG. 14 illustrates one embodiment of a process by which the microcontroller 151 and/or central processing unit 161 estimates the gas content 215 in units of volume/time. After the multiphase meter 10 has been calibrated, lookup tables 232 and 233 are populated with data pairing water cut fractions with corresponding sets of calibration curve parameters. Each set of calibration curve parameters is for an estimated gas content formula, for a given water cut fraction, that correlates a detected difference signal 207 with an estimated gas content 215. The lookup table values are generated for several possible capacitance signals by solving formulas that fit the family of calibration curves 216 (FIG. 13) to the calibration data. When the multiphase meter 10 is placed in normal field operation, the estimated water fraction 203 is looked up in table 233 to identify the calibration parameters or coefficients of an estimated gas content formula appropriate for the estimated water fraction 203. The arithmetic difference between the first and second signals 200 and 201 is also computed, and the resulting difference value 207 plugged into the appropriated estimated gas content formula to determine the estimated gas content 215.

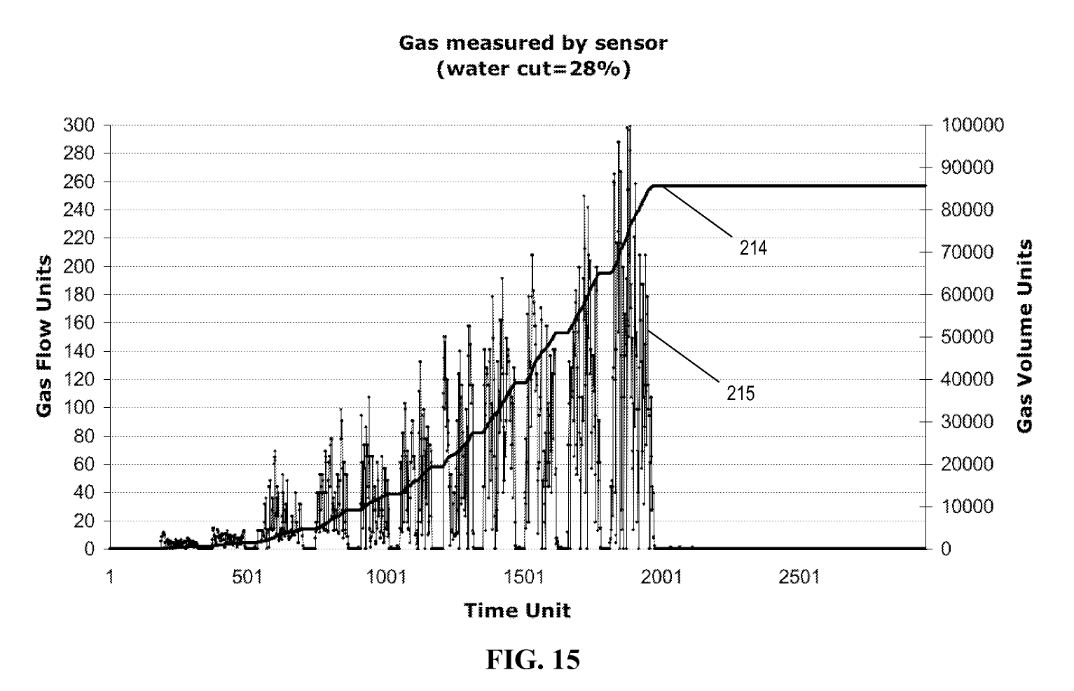

As illustrated in FIG. 12, the relationship between the actual gas fraction 207 and the difference value 206 is a very noisy one. In FIG. 15, the estimated instantaneous gas content 215—plotted against the first, left Y-axis—is likewise noisy. Usable results, however, can be obtained by integrating the estimated instantaneous gas content 215 over time. FIG. 15 illustrates the integral 214 of the estimated instantaneous gas content 215 over time in a simulation that used a 28% water cut. The integral 214 is plotted in arbitrary units of volume against the second, right Y-axis.

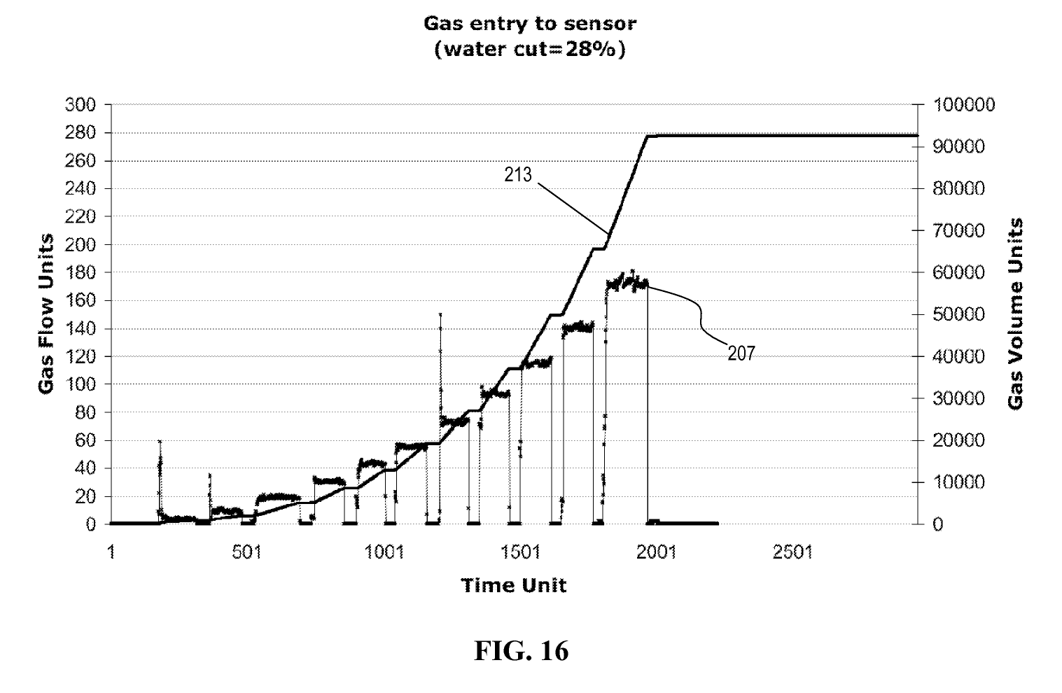

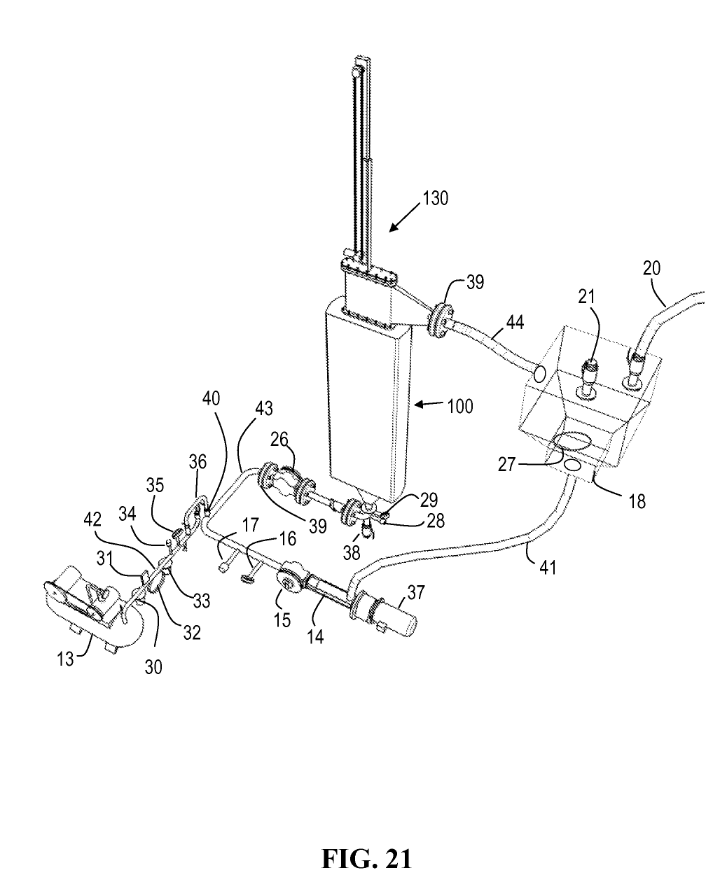

FIG. 16 illustrates the integral 213 of the measured gas flow rate signal 207 from the same 28% water cut simulation used in connection with FIG. 15. The gas flow rate signal 207 was obtained from the gas flow meter 31 shown in FIG. 21. The gas flow rate signal 207 is plotted in arbitrary units of volume/time against the first, left Y-axis. The integral 213 is plotted in units of volume against the second, right Y-axis.

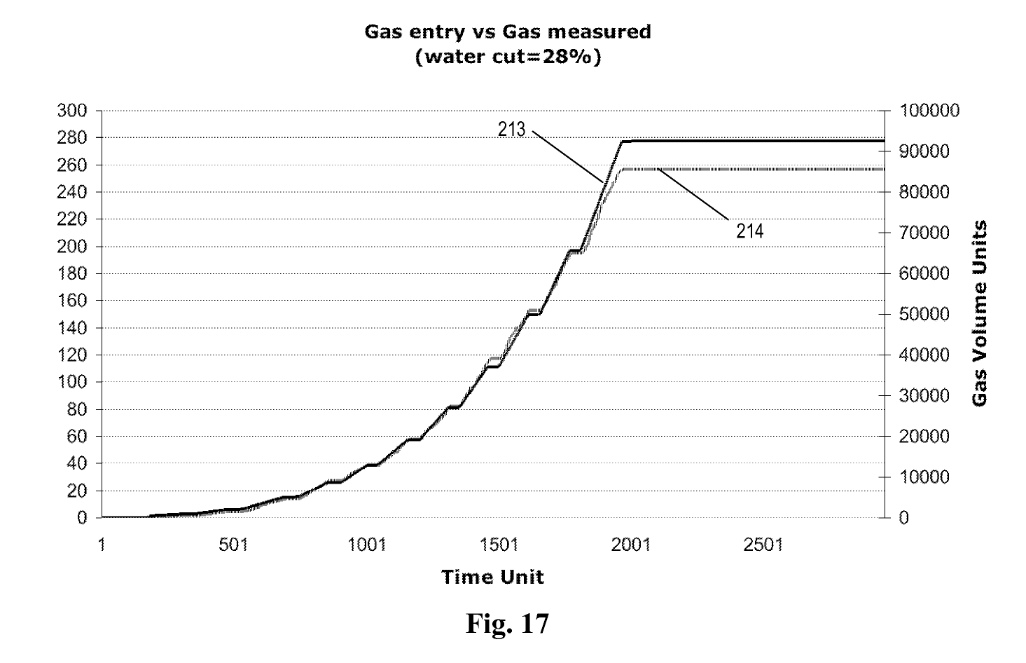

FIG. 17 contrasts the integral 213 of the measured gas flow rate signal 207 with the integral 214 of the estimated instantaneous gas content 215, illustrating the error between them. By a process of multiple repeated tests, the calibration values populating tables 232 and 233 can be adjusted to minimize the error.

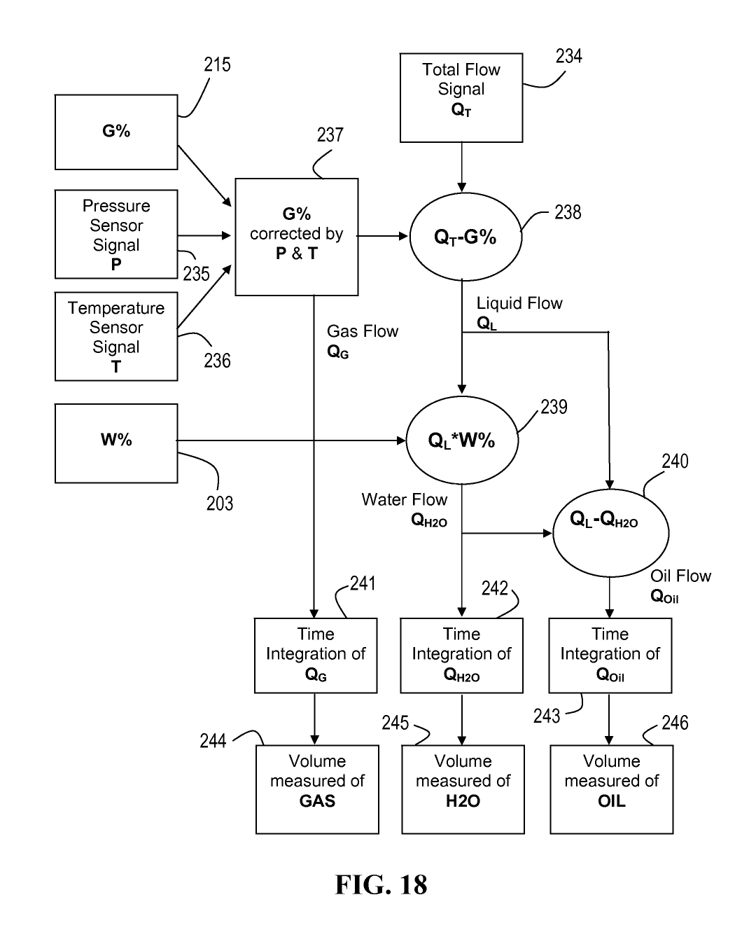

As indicated above, usable estimates of relative gas, water, and oil contents are estimated by integrating estimated instantaneous values over time. FIG. 18 illustrates such a process that is preferably executed by microcontroller 151 and/or central processing unit 161. In function block 234, a total flow signal value Q_{T}, in units of volume/time, is obtained from the total flow meter 26 illustrated in FIG. 21. In function block 237, the estimated instantaneous gas content 215 is corrected by temperature and pressure signals 235 and 236 (obtained from temperature sensor 29 and pressure sensor 28, respectively) to obtain a temperature- and pressure-corrected estimated instantaneous gas fraction content Q_{G} value, also in units of volume/time. In function block 238, an estimated instantaneous liquid fraction content Q_{L} is calculated by subtracting the temperature- and pressure-corrected estimated instantaneous gas fraction content Q_{G} from the total flow value Q_{T}. The estimated instantaneous liquid fraction content Q_{L} is also in units of volume/time.

In function block 239, the estimated water fraction content Q_{H20} is calculated by multiplying the estimated instantaneous liquid fraction content Q_{L} by the estimated water cut fraction 203. In function block 240, the estimated oil fraction content Q_{Oil} is estimated by subtracting the estimated water fraction content Q_{H20} from the estimated instantaneous liquid fraction content Q_{L}.

In function block 241, the temperature- and pressure-corrected estimated gas fraction content Q_{G} is integrated over time to produce an estimated gas volume 244. In function block 242, the estimated water fraction content Q_{H20} is integrated over time to produce an estimated water volume 245. In function block 243, the estimated oil fraction content Q_{Oil} is integrated over time to produce an estimated oil volume 246.

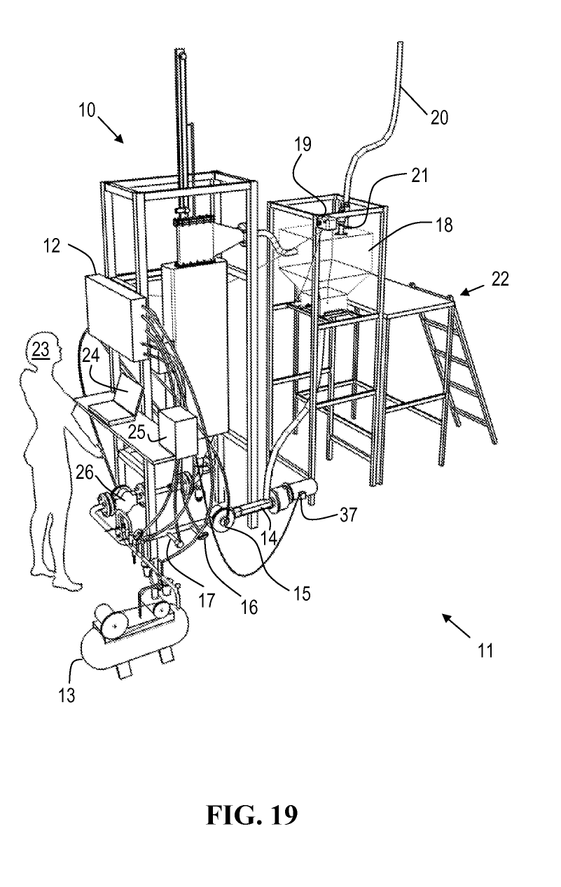

FIGS. 19-21 illustrate a calibration and test loop 11 for calibrating the multiphase meter 10 and other testing probes. The loop 11 includes means for introducing a simulated multiphase production, including gas, oil and water. For example, gas may be injected through an air compressor 13, passed through a first dehumidifier 30, a gas flow meter 31, a gas heater 32, a second dehumidifier 33, a gas pressure sensor 34, a gas temperature sensor 35 and an anti-return valve 36.

A liquid fraction is introduced into the loop 11 at a specific liquid ingress point 21, which deposits liquid into a preferably transparent liquid tank 18. The liquid tank 18 is preferably located in a more elevated position than the multiphase sensor 10. Liquid is heated by a liquid heater or calefactory 27, and pumped through a liquid pipe 41 by a liquid pump 14. The loop 11 also optionally includes a liquid flow meter 15, a liquid temperature sensor 16 and a liquid pressure sensor 17. In a preferred embodiment, the pump 14 is an eccentric screw pump driven by an electric motor 37. In an alternative embodiment, the pump 14 is a multiphase pump.

Additionally, the loop 11 includes a mixing point 40 for mixing the injected gas and liquid. An inferior multiphase pipe 43 downstream from the mixing point 40 is joined to an input flange 39 at the input of the multiphase meter 10 to direct the simulated production through the multiphase meter 10. Signals from the total flow meter 26, the total flow sensor 28, and the total flow pressure sensor 29, located downstream of the input flange 39, are used in the calibration procedure.

After passing up through the multiphase sensor 100, the simulated production exits the multiphase meter 10 through exit flange 39. Exit flange 39 is joined to a superior multiphase pipe 44 that re-circulates the simulated production to the liquid tank 18. The gas fraction of the recirculated simulated production entering the tank 18 separates from the liquid fraction and is ventilated through ventilation pipe 20. In this way, the liquid phase is re-circulated and the previously injected gas phase is ventilated out.

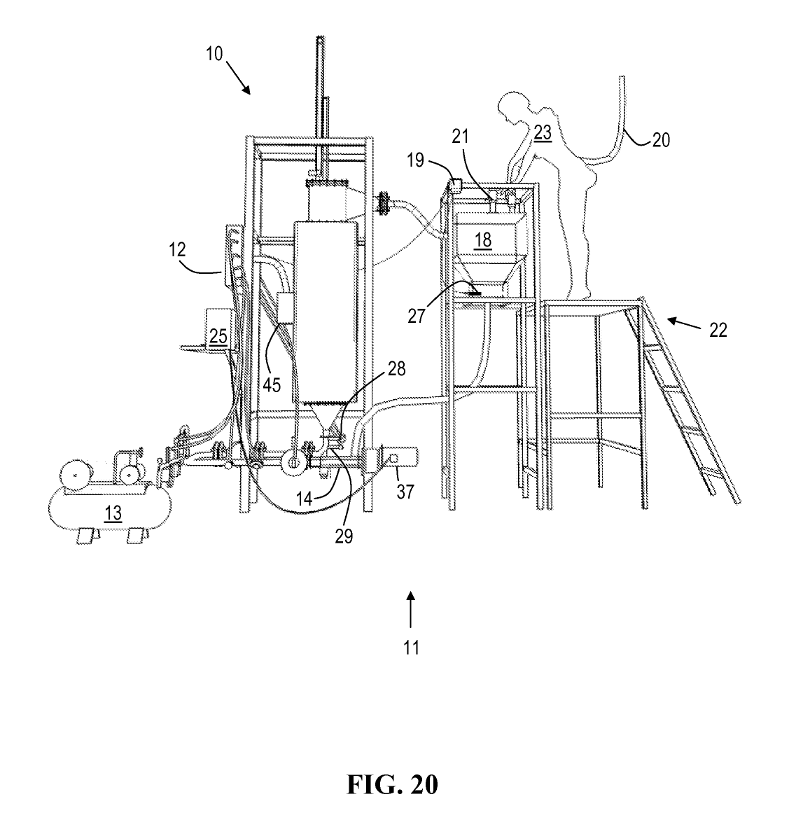

FIG. 19 illustrates an operator station including a laptop 24 for operating the calibration. The laptop 24 stores output data obtained during the calibration phase. The laptop 24 also provides operator control over a motor pump speed control 25. FIGS. 19 and 20 illustrate the electronic control unit 12 that processes data generated during a calibration procedure. FIGS. 19 and 20 also illustrate a personnel platform 22 to provide an operator 23 with access to the liquid tank 18.

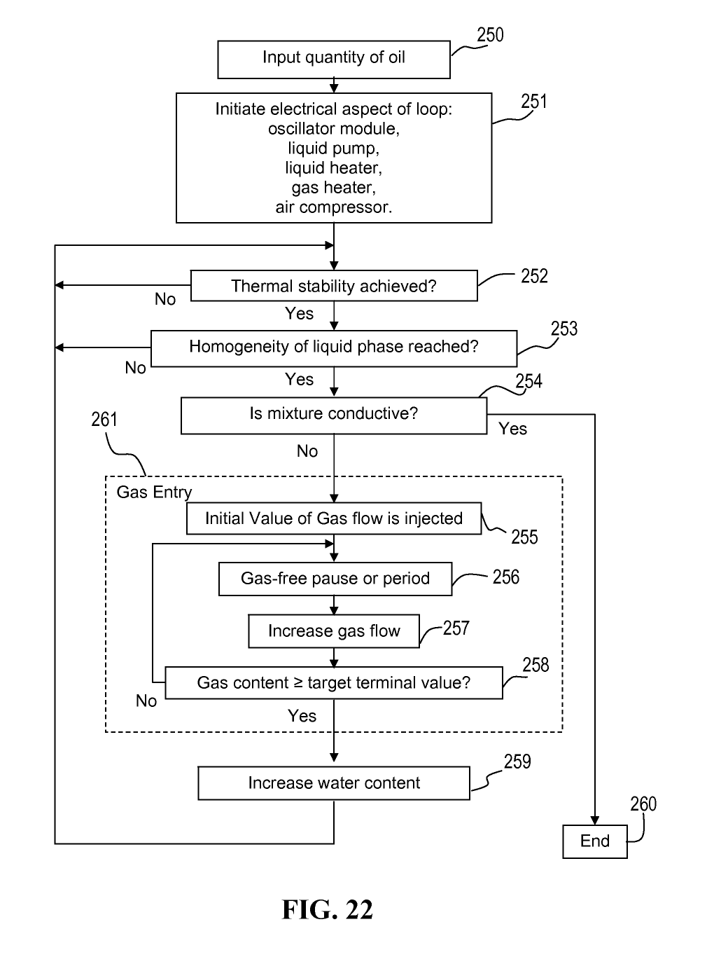

FIG. 22 illustrates one embodiment of a calibration process. In step 250, a quantity of input (e.g., 20 liters) is injected into the calibration loop 21 through the liquid ingress point 21. In step 251, a loop initialization routine initializes electrical and mechanical components of the loop, including the oscillator module 45, the liquid pump 14, the liquid calefactor 27, the gas heater 32, and the air compressor 13. In decision blocks 252 and 253, sensor values are checked to determine whether thermal stability and homogeneity of the liquid phase have been achieved. Thermal stability and homogeneity of the liquid phase are characterized by peripheral and central capacitance values that are are stable over time, and whose difference signal is near zero.

In decision block 254, sensor values are checked to determine if the mixture is conductive, which is characterized by both capacitance values suddenly rising to maximum values. The liquid fraction is formed by oil and water in a determined proportion. When this is less than about 50% water, the liquid is non-conductive and acts as a dielectric with a dielectric constant that is a function of the water content. If the liquid fraction is predominately water, then the mixture will be conductive, and the calibration procedure is terminated in block 260.

If thermal stability and homogeneity have been achieved, and the mixture is not conductive, then a gas injection subroutine 261 is initiated. In block 255, an initial amount of gas flow is injected into the calibration loop 11 for an established period of time, followed a gas-free pause or period 256 to facilitate re-stabilization of the liquid phase. After each gas-free pause or period 256, gas is again injected (in block 257) at an increased flow rate of between 1% and 5%. The gas injection subroutine 261 continues to incrementally increase the gas flow injections until a terminal flow rate is achieved. In decision block 258, the subroutine determines whether the terminal flow rate has been reached or exceeded. If so, then in block 259, the water content is increased and the process resumes at block 252. Through successive tests using incrementally greater gas and water contents, the sensor is calibrated over a complete range of operation. A sensitivity analysis may also be performed by testing different types of oil and water salinities.

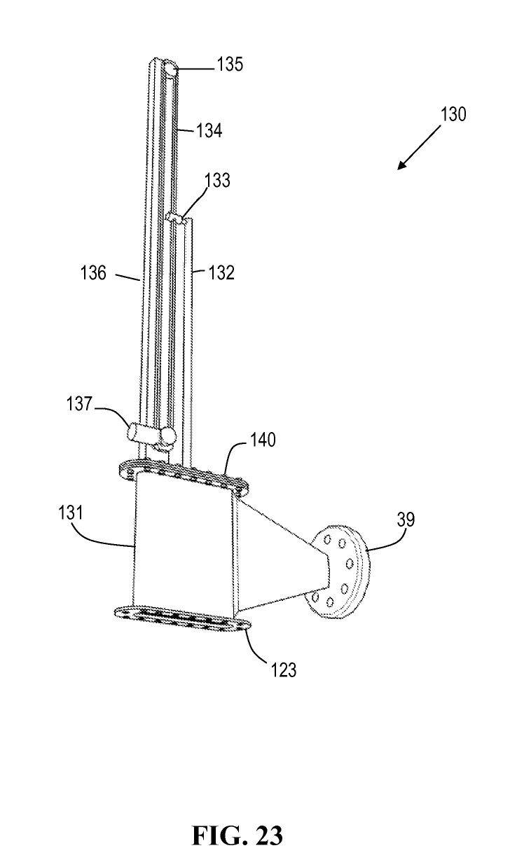

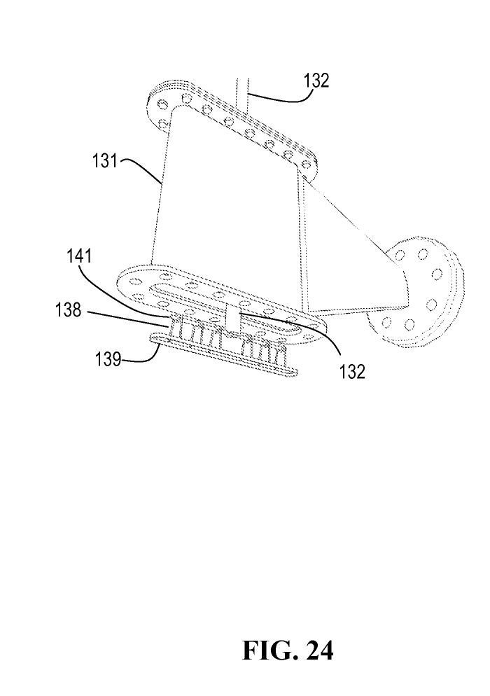

FIGS. 23 and 24 illustrate a cleaning accessory 130 for the multiphase sensor 100. Ad hoc cleaning accessory 130 includes an ad-hoc formed pipe 131 with an inferior ad-hoc flange 123 shaped to mate the similarly formed superior flange 123 of the multiphase sensor 100. A standard flange 39 is provided to connect the cleaning accessory 130 to a pipe that receives the output. A shaving device 139 to clean the interior walls 105 of the multiphase sensor 100 is connected, via spring supports 138, to a rigid horizontal shaft 141, which is in turn connected to a vertical shaft 132.

The shaving device 139—preferably formed of nylon or polytetrafluoroethylene—is able to extend from a retracted position inside the ad-hoc pipe 131 of the cleaning accessory 130 down into the chamber 120 of the multiphase sensor 100. After descending into chamber 120, the shaving device 139 is raised back up. As the shaving device 139 ascends inside chamber 120, it sweeps the interior walls 105, dragging up any fixed deposits on the walls 105.

In one embodiment, the vertical shaft 132 is moved manually. In the depicted embodiment, the vertical shaft 132 is remotely operated. An electric motor and reducer 137 acts on a chain or belt 134 suspended over pulley 135. The motor 137 and pulley 135 are mounted on a rigid longitudinal structure or chassis 136. The chain or belt 134 moves a rigid link 133 connected to the vertical shaft 132.

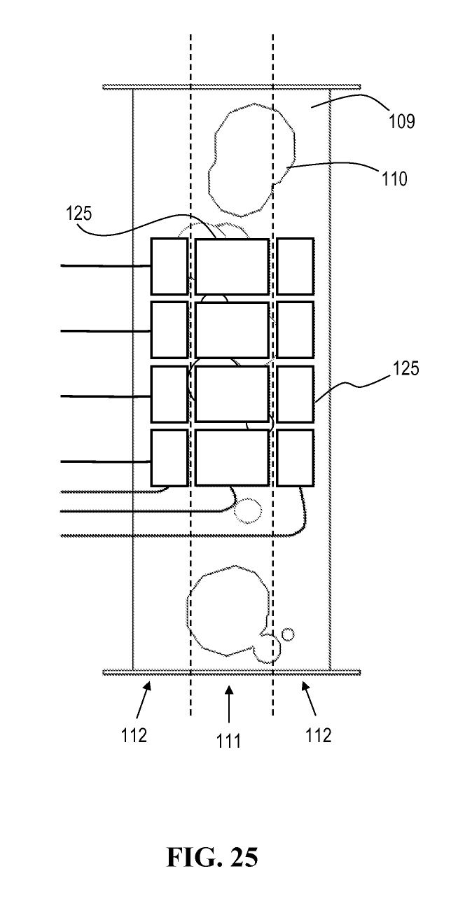

FIG. 25 illustrates an alternative embodiment a multiphase sensor 100 in which each of the first and second capacitor assemblies 107 and 108 comprise a plurality of pairs of conductive plates to enhance resolution of information about the inhomogeneous degree of multiphase flow. Image-processing techniques may be used with this embodiment to measure each phase content.

In an inhomogeneous flow, signals 200 and 201 are not stable. The control signal 202 is also very noisy, as illustrated in FIG. 12 at approximate time 250, with an average near zero. In an inhomogeneous flow, water and oil are separated like bubbles. As oil bubbles cross by each capacitor, a reduction in this signal is perceived. As water-bubbles cross each capacitor (peripheral or central), an elevation in this signal is perceived. The use of multiple pairs of conductive plates in each of the first and second capacitor assemblies 107 and 108 facilitates identification, with increased spatial resolution, of water bubbles, along with more precise water cut determinations. Accordingly, the embodiment of FIG. 25 enables measurement of the homogeneous degree of the flow.

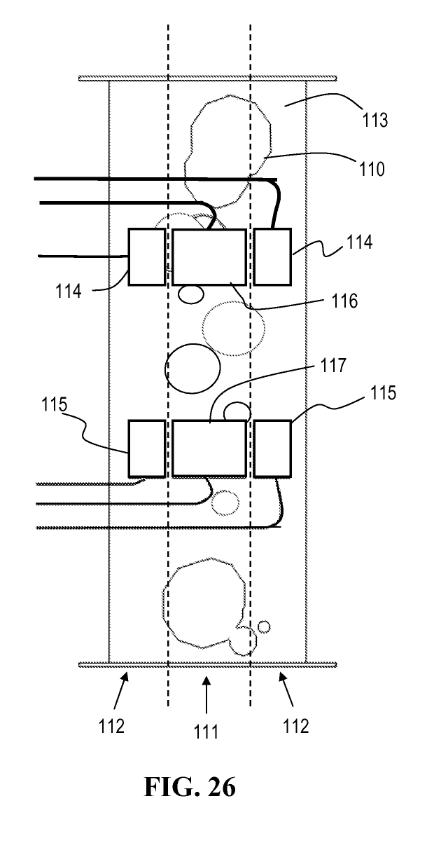

FIG. 26 illustrates another alternative embodiment a multiphase sensor 100 designed to detect relative gas, water, and oil content in the presence of a conductive liquid phase 113. In this embodiment, a first set of peripheral 115 and central 117 plates transmit signals to a vertically displaced second set of peripheral 114 and central 116 plates that receive the signals. The multiphase meter 10 measures the delay and distortion in the received signals, which are a function of flow content and the flow's electrical admittance. In this way, it is possible to measure water content and gas content when the liquid phase is non-dielectric.

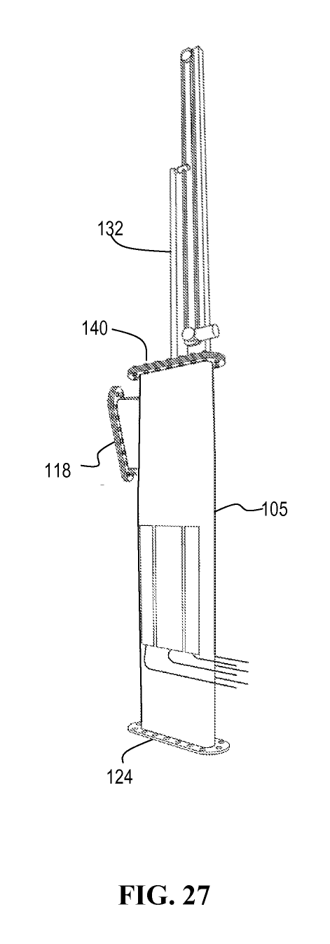

FIG. 27 illustrates an alternative embodiment of the multiphase sensor 100 that incorporates the cleaning accessory 130 by lengthening the internal walls 105 of the multiphase sensor 105 to replace the ad-hoc formed pipe 131 and inferior flange 123 illustrated in FIG. 23. In this way, the cleaning device 139 slips across a continuous surface without any breaks. In this embodiment, a lateral superior output is provided, including respective flange 118.

Having thus described exemplary embodiments of the present invention, it should be noted that the disclosures contained in FIGS. 1-27 are exemplary only, and that various other alternatives, adaptations, and modifications may be made within the scope of the present invention. Accordingly, the present invention is not limited to the specific embodiments illustrated herein, but is limited only by the following claims.

We claim:

1. A multiphase meter for measuring the fractional contents of different components of a hydrocarbon-containing multiphase flow, the meter being characterized in that it comprises:
a first capacitor circuit for sensing a first electrical characteristic dependent on the multiphase flow; and
a second capacitor circuit for sensing a second electrical characteristic dependent on the multiphase flow; and
circuitry electrically coupled to the first and second capacitor circuits and functionally arranged to evaluate the electrical characteristics from the first and second capacitor circuits to estimate the relative fractional contents of different components of the multiphase flow.

2. The multiphase meter of claim 1, further characterized in that:
the different components of the multiphase flow include water, oil, and gas; and
the circuitry is functionally arranged to estimate the relative amounts of water, oil, and gas in the multiphase flow.

3. The multiphase meter of claim 2, further characterized in that the meter estimates the relative amounts of water, oil, and gas without separating gas and liquid phases of the multiphase flow into physically segregated flow channels.

4. The multiphase meter of claim 3, further characterized in that the sensed electrical characteristics are the sensed capacitances, permittivities, susceptibilities, impedances, admittances, or reactances of the respective capacitor circuits or their dielectric mediums.

5. The multiphase meter of claim 1, further characterized in that the first and second capacitor circuits are each comprised of parallel conductive capacitor plates, and wherein the plates of the first capacitor circuit are coplanar with the plates of the second capacitor circuit.

6. The multiphase meter of claim 1, further characterized in that:
the first and second capacitor circuits are each comprised of parallel conductive capacitor plates;
the multiphase flow is directed to flow between the plates; and
the parallel conductive capacitor plates are electrically insulated from the multiphase flow.

7. The multiphase meter of claim 1, the meter being further characterized in that it comprises:
a chamber for receiving and directing the multiphase flow vertically upward; and
the chamber having a central flow region unseparated from and in cross-sectional continuity with one or more peripheral flow regions.

8. The multiphase meter of claim 7, further characterized in that the chamber has a non-circular cross-section.

9. The multiphase meter of claim 7, further characterized in that the chamber has a rectangular cross-section.

10. The multiphase meter of claim 7, further characterized in that the chamber is mounted in a vertical orientation to allow gravity to cause a gas phase of the incoming multiphase flow to preferentially concentrate along the central flow region, leaving a liquid phase to preferentially flow through the peripheral flow region.

11. The multiphase meter of claim 7, further characterized in that the chamber has a chamber entrance and a chamber exit for passing the multiphase flow, and wherein the minimum distance path for the multiphase flow is through the central flow region of the chamber, and wherein any portion of the multiphase flow flowing through the peripheral flow region travels a greater distance than said minimum distance path.

12. The multiphase meter of claim 11, further characterized in that when the chamber is vertically mounted, the chamber entrance is positioned immediately below the central flow region, the chamber entrance having interior sides that taper from a narrow inlet aperture upward and outward toward interior walls of the chamber.

13. The multiphase meter of claim 12, further characterized in that:
the first capacitor circuit includes capacitive plates positioned about the central flow region for sensing a first electrical characteristic dependent on the multiphase flow through the central flow region; and
the second capacitor circuit includes capacitive plates positioned about the one or more peripheral flow regions for sensing a second electrical characteristic dependent on the multiphase flow through the one or more peripheral flow regions.

14. The multiphase meter of claim 13, further characterized in that the peripheral flow region comprises two peripheral flow sections adjacent opposite sides of the central flow region, and wherein the capacitive plates of the second capacitor circuit are positioned about both peripheral flow sections, and the plates of the first capacitor circuit are positioned about the central flow region in between the peripheral flow sections.

15. The multiphase meter of claim 13, further characterized in that the first capacitor circuit has a capacitance that is a function of relative water, oil, and gas contents of the multiphase flow through the central region, and the second capacitor circuit has a capacitance that is a function of relative water, oil, and gas contents of the multiphase flow through the one or more peripheral flow regions.

16. The multiphase meter of claim 1, further characterized in that the circuitry estimates a relative gas content of the multiphase flow from a difference between the sensed electrical characteristics of the first and second capacitor circuits.

17. The multiphase meter of claim 16, further characterized in that the circuitry estimates the relative gas content from the arithmetic difference between the sensed electrical characteristics of the first and second capacitor circuits.

18. The multiphase meter of claim 1, further characterized in that the circuitry estimates a relative water content of the multiphase flow from the sensed electrical characteristic of the second capacitor circuit.

19. The multiphase meter of claim 1, further characterized in that the circuitry estimates the relative gas content as a function of the estimated water content and a difference between the sensed electrical characteristics of the first and second capacitor circuits.

20. The multiphase meter of claim 1, further characterized in that the circuitry estimates the relative contents of different components of a multiphase flow from a well as a function of interpolated calibration data derived from electrical characteristics sensed from one or more of the capacitor circuits during a calibration procedure in which several known mixtures of simulated multiphase flow are directed through the multiphase meter.

21. The multiphase meter of claim 20, further characterized in that the circuitry estimates a water content of the multiphase flow as a function of interpolated calibration data derived from electrical characteristics sensed from the second capacitor circuit.

22. The multiphase meter of claim 21, further characterized in that calibration data used to estimate water content is interpolated using at least a second-order polynomial fit to data derived from the calibration procedure.

23. The multiphase meter of claim 20, further characterized in that the circuitry estimates a gas content of the multiphase flow as a function of the estimated water content and interpolated calibration data relating a difference between the sensed electrical characteristics of the first and second capacitor circuits, for an estimated water content, to an estimated gas content.

24. The multiphase meter of claim 23, further characterized in that calibration data used to estimate gas content is interpolated using a plurality of differently-sloped straight-line segment fits to data derived from the calibration procedure.

25. The multiphase meter of claim 23, further characterized in that the circuitry estimates a gas volume as a function of detected pressure and temperature signals.

26. The multiphase meter of claim 20, further characterized in that the circuitry integrates instantaneously estimated fractional contents of different components of the multiphase flow over time in order to obtain more accurate estimates of the fractional contents of different components of the multiphase flow.

27. The multiphase meter of claim 5, further characterized in that the first and second capacitor circuits are each comprised of conductors of equal total area and separation, so that if a multiphase flow is homogeneous through both the central and peripheral flow regions, the sensed first and second electrical characteristics are approximately the same.

28. The multiphase meter of claim 1, further characterized in that each of the first and second capacitor circuits comprise a plurality of pairs of conductive plates to enhance resolution of information about the homogeneity of the multiphase flow.

29. The multiphase meter of claim 1, further characterized in that:
each of the first and second capacitor circuits comprises vertically displaced first and second sets of conductive plates;
the first set of conductive plates transmits signals vertically through the multiphase flow;
the second set of conductive plates receives the transmitted signals; and
the circuitry measures the delay and distortion in the received signals;
whereby the meter is operable to measure the fractional contents of different components of the multiphase flow in conditions of a non-dielectric liquid phase.

30. The multiphase meter of claim 7, further characterized in that it comprises a cleaning accessory that travels in a vertical direction to scrape interior walls of the chamber.
